(19) United States
(12) Patent Application Publication
(10) Pub. No.: US 2005/0092800 A1
(43) Pub. Date: May 5, 2005

(54) Rack for carrying enlongated objects on the vertical back of a vehicle

(76) Inventor: Donna M. Wilson, Long Beach, CA (US)

Correspondence Address: RICHARD C. CALDERWOOD, 2775 NW 126TH AVE, PORTLAND, OR, 97229-8381, US

(21) Appl. No.: 10/697,059

(22) Filed: Oct. 30, 2003

(51) Int. Cl. B60R 11/00

(52) U.S. Cl. 224/513; 224/519

(57) ABSTRACT

A removable rack system for carrying elongated cargo such as surfboards or canoes on vehicles such as RVs, which have a tall, substantially vertical surface such as the back end of the vehicle. A rack is mounted to the bumper and includes vertical and horizontal rails for positioning support bars that hold the cargo in place, and a tray is mounted to the receiver hitch or to bars extending from the bumper brackets, to support the weight of the cargo. No damage or alteration of the vehicle is required, and no special tools are required. The tray may include a receiver for daisy-chaining a second hitch for towing a trailer.

### BACKGROUND OF THE INVENTION

1. Technical Field of the Invention

This invention relates to racks for carrying sporting goods, elongated items, and the like on the substantially vertical backs of vehicles such as motor homes.

2. Background Art

Racks have been developed for carrying a wide variety of objects on the outside of various motor vehicles. Pickup trucks have been adapted with racks for carrying lumber, ladders, pipe, and other elongated objects in a horizontal position, with the objects being supported by a rear lateral bar generally even with the tailgate of the truck, and by a front lateral bar above the passenger cab. These pickup truck racks mount to the vertical holes in the sides of the bed box. Sedans have been adapted with racks for carrying bicycles, kayaks, and other objects in a generally horizontal position above the roof of the passenger compartment. These sedan racks mount to the roof, either to the rain gutters, to the roof at the “door frames”, or to factory rack mounts, or in some instances to the trunk. SUVs have been adapted with racks for carrying bicycles behind the rear doors or lift gate, with the bicycle frames hanging from a horizontal rack bar which extends longitudinally backward from the vehicle, with the bicycles positioned sideways. These SUV racks typically mount to the trailer hitch. Hatchbacks and wagons have been adapted with racks for carrying bicycles in this same sideways, frame-hung manner. These racks mount to the lift gate.

In addition to bicycle racks and the like, manufacturers have recently begun offering hitch-mounted racks or trays for carrying toolboxes, coolers, and the like.

With the exception of original factory racks, it is generally understood to be desirable that rack installations not cause any permanent alteration, damage, or structural changes to the vehicle. Such alteration or damage would reduce the resale value of the vehicle, as well as the vehicle's aesthetic appeal to the current owner.

One group of vehicles has, until the advent of the present invention, been much neglected and underserved by the aftermarket rack industry. There have not previously been any racks available which have been optimized for use with motor homes, motor coaches, recreational vehicles (RVs), campers, trailers, and other vehicles which have a substantially vertical rear end or stem. It is a common sight to see an RV driving down the highway with a variety of items strapped to its roof, often with additional items hanging from its rear roof access ladder and even its spare tire.

Until now, RV owners had to carry elongated cargo, such as surfboards, canoes, kayaks, and ladders, to the roof and strap it down in a horizontal position. This exposes the cargo directly to the full blast of the passing air and weather, adds to the already significant air resistance of the vehicle, and is dangerous and inconvenient for the owner, who is forced to scale the vehicle's ladder (or, worse, a separate ladder) with unwieldy cargo. Furthermore, it is dangerous for other motorists, as the items are sometimes blown off the roof, landing in traffic.

What is needed, then is an improved apparatus and method for securing elongated cargo items to the back of a vehicle which has a substantially vertical or a significantly tall rear end.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows an RV equipped with one embodiment of a rack according to the present invention, illustrating the rack configured for carrying surfboards.

FIG. 2 shows the RV with its rack configured for carrying a canoe.

FIG. 3 shows an exploded view of the components of one embodiment of a rack such as may be used with an RV.

FIG. 4 shows the tray with its pass-through hitch system in greater detail.

FIG. 5 shows the rack system before installation onto the RV.

FIG. 6 shows details of an alternate bumper mounting system.

FIG. 7 shows an exploded view of the alternate bumper mounting system.

### DETAILED DESCRIPTION

In this disclosure, the term “longitudinal” refers to the generally front-to-back direction, or the direction of travel of the vehicle, while the term “lateral” refers to the generally left-to-right direction.

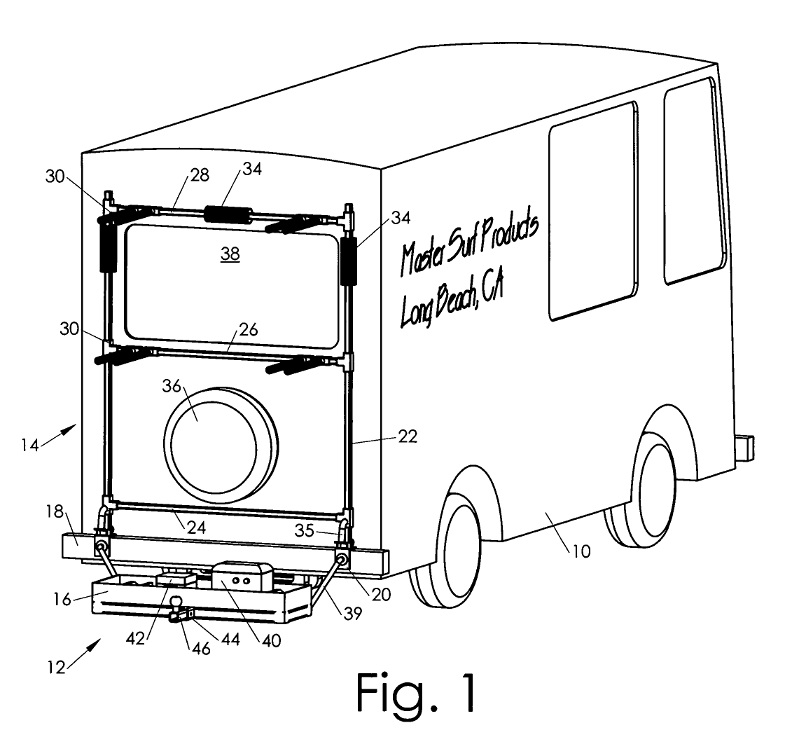

FIG. 1 illustrates a vehicle 10, such as an RV, equipped with a rack system 12 according to one embodiment of this invention. The rack system includes a rack 14 and an optional tray 16. In some applications, it will be desirable to have a tray or the like to support the majority of the weight of items being carried in the rack. In other applications, the rack carries the majority of the weight of the items.

Ideally, the rack is mounted to the bumper 18 of the RV by bumper mounts 20. In other embodiments, the rack may be supported by the tray or other components of the RV, such as the trailer hitch, but mounting to the bumper will generally provide the most positive mounting, with the greatest resistance to rocking and swaying.

The bumper mounts support vertical rails 22 which, in turn, support horizontal rails. In one embodiment, there is a bottom horizontal rail 24, a middle horizontal rail 26, and a top horizontal rail 28. Various ones of the rails, such as the top and middle horizontal rails, are equipped with support bars 30 which hold cargo, such as surfboards 32, in position. The support bars are movable along the rails. In some embodiments, the support bars are equipped with locking mechanisms (not shown) which enable the user to positively position them to hold the cargo in a fixed position.

Ideally, the rack is not connected to the body of the RV, and is supported only at the bumper. The rails may be provided with pads 34 which protect the RV from damage by any contact from the rails. In some embodiments, the rack is configured such that the pads are kept in constant contact with the RV, to improve the longitudinal stability of the rack. For example, compression springs 35 may provide longitudinal pressure between the bumper mounts and the vertical rails, rotating the vertical rails toward the RV.

In one embodiment, the horizontal rails can be moved and positioned along the vertical rails, whether it be to position the support bars for particular cargo items, or to avoid vehicle components such as a spare tire 36 or a rear window 38.

The tray 16, or other suitable mechanism such as a bar, supports the weight of the cargo items held in the rack. In some embodiments, the tray is stabilized by stabilizer bars 39 which are coupled to the tray (ideally, near its left and right ends for maximum leverage) and to the rack, to reduce any tendency of the tray to rock or yaw. In one embodiment, the stabilizer bars are coupled to the bumper mounts. In other embodiments, the stabilizer bars may be coupled to the vertical rails, the bumper, the RV frame, or the hitch. In some embodiments, the stabilizer bars may be replaced by chains, straps, or other devices for stabilizing the tray by keeping it under tension.

Additionally, the tray provides storage for other items which are not suitable for being carried in the rack, such as a small barbeque 40. In one embodiment, the tray is equipped with a permanently affixed lockbox 42 for securing small valuables. Surfers have a known problem of securing their wallets, RV keys, and other valuables which cannot be left inside the RV, but which are readily lost if the person carries the items while surfing, and which are often stolen if left on the beach. Ideally, the lockbox has a combination lock, such that the user does not need to take a lockbox key with them or try to hide it on the beach.

In one embodiment, the tray is mounted to the RV's receiver hitch (not visible). In other embodiments, it may be coupled to the bumper. In either case, the user may have a trailer or a towed vehicle which is also needed. To facilitate this, the tray provides its own receiver 44 to which a hitch 46 may be coupled, for towing the trailer or vehicle, or perhaps for daisy-chaining a second tray.

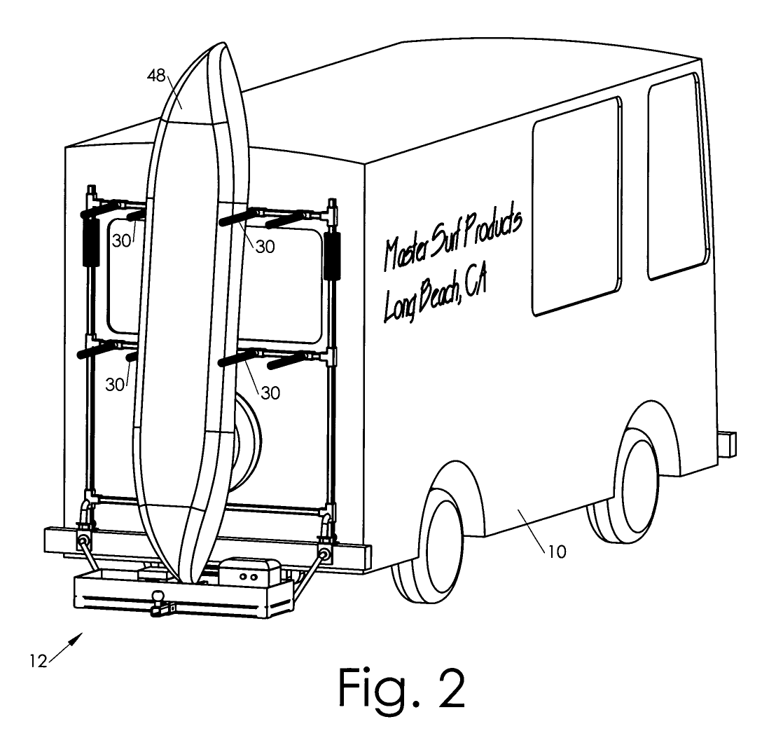

FIG. 2 illustrates the RV 10 with the support bars repositioned for holding a canoe 48. The horizontal rails can be provided with any suitable number of support bars. Some of the support bars may be repositionable, while others may be permanently mounted in a fixed position.

In the interest of simplicity, the drawings do not show the various means by which surfboards, canoes, and the like may be secured to the rack. In some cases, the cargo can be attached with ropes or bungee cords, or with motorcycle tie-down straps, or the like. In some embodiments, the rails or the support bars may be provided with locking mechanisms to prevent removal of the cargo items. One especially useful embodiment includes a retractable, ratcheting cable which can be pulled out from the open end of a support bar and locked onto an adjacent support bar. This is especially useful with cargo items which, owing to their shape or to their bulk, cannot easily be removed simply by sliding them upward until they clear the support rails. For example, the fin of a surfboard will prevent the surfboard from passing upward between support bars which have been positioned firmly against the top and bottom of the surfboard.

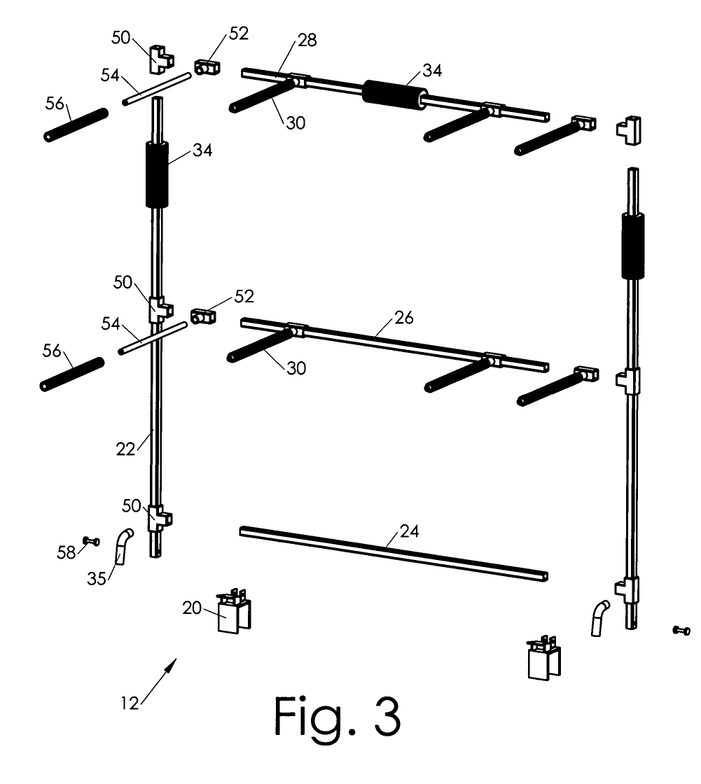

FIG. 3 illustrates an exploded view of the components of one embodiment of a rack 12. The rack includes bumper mounts 20 for connecting to the vehicle. The bumper mounts are coupled to the vertical rails 22 and/or the bottom horizontal rail 24. The horizontal rails are slidably connected to the vertical rails by rail connectors 50. Some or all of the rail connectors may have means (not shown) for locking them in place, such as set-screws, cam levers, or the like which enable the rails to be moved to and held in any arbitrary position, or means (not shown) for moving to and holding in predetermined positions, such cotter pins or as the well-known system of holes and snap-out buttons which are used in many telescoping tent and canopylegs.

The horizontal rails (and, optionally, the vertical rails) are equipped with support bars 30 for holding cargo items in place. Some of the support bars may be directly coupled to the rails, such as by welding, while others may be coupled by bar connectors 52. The bar connectors may be provided with positioning means such as those provided for the rail connectors. A support bar includes a rod or tube 54 and, optionally, a pad 56.

In some embodiments, the bumper connectors are rigidly coupled to the vertical rails. In other embodiments, the bumper connectors are pivotably connected to the vertical rails, such as by hinge pins or bolts 58. In some such embodiments, compression springs 35 may be provided to keep the rack against the vehicle under tension.

In some embodiments, the bar connectors and the pads 34 are slid onto the rails before the rail connectors are in place. In other embodiments, the bar connectors and even the rail connectors may be configured such that they can be added later, without disassembling the rails.

In some embodiments, other or additional means may be provided for preventing the rack and/or the cargo from damaging the back of the RV. For example, the rack or the RV may be equipped with adhesive-backed rubber buttons such as those used to prevent bug deflectors from vibrating against the hoods of pickup trucks.

The tray may be equipped with fixed or movable pads for supporting damageable items such as surfboards. The tray may be equipped with various means for facilitating tie-down of the goods in the tray and in the rack, such as eyebolts to which the user may connect surfboard leashes. The tray may be manufactured of expanded steel. The tray may be provided with a variety of adapters or reducers for coupling to a variety of hitches and receivers.

The bumper connectors may have any suitable shape. They may simply slip down over the bumper, or they may slide in over the ends of the bumper. They should be held in place some positive retention means such as rubber-backed clamps, bolts, screws, locks, or the like. In some embodiments, the user may remove the rack while leaving the tray in place, or vice versa.

The user might use the support bars to hold items in a horizontal position, rather than vertically as shown.

While the rack has been illustrated with reference to an embodiment in which the horizontal rails can be slid to various positions along the vertical rails, there are also embodiments in which the opposite is true, in which the vertical rails slide laterally along the horizontal rails. And while the connectors have been illustrated in a T configuration, other configurations are certainly within the scope of this invention, such as L shapes. And while the connectors have been illustrated as holding the vertical and horizontal rails in substantially the same plane, in other embodiments, they could occupy different, parallel planes such that both the horizontal rails and the vertical rails may extend beyond the other, providing maximum flexibility in configuration (whereas, in the embodiment illustrated in FIG. 1, the lateral separation of the vertical rails is dictated by the length of the horizontal rails).

The numbers of rails need not be exactly as shown. The rails may be manufactured of any suitable material, such as square box galvanized steel, round aluminum tubing, fiberglass, or other materials.

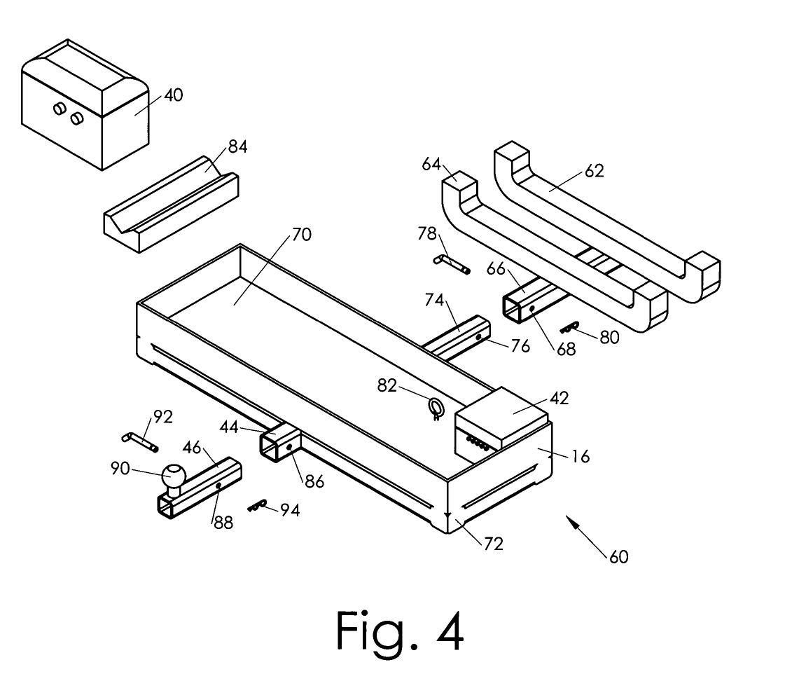

FIG. 4 illustrates the daisy-chain or pass-through hitch system 60. The vehicle (not shown) includes a receiver hitch 62 which includes means 64 for coupling to the frame of the vehicle. The receiver hitch includes an open-ended receiver 66, which typically includes a lateral hole 68. The tray 16 includes a box 70 coupled to a frame 72. The frame includes a hitch 74 which is sized for mating with the receiver 66, and typically includes a lateral hole 76. The hitch is inserted into the receiver until the lateral holes are aligned, a retaining pin 78 is inserted through the holes, and a cotter pin 80 is engaged with the retaining pin to keep it from coming loose.

The box may be equipped with a variety of equipment such as a lockbox 42, tie-down points such as eyebolts 82, and so forth. The box may further include removable equipment 40 and a variety of pads 84 for cushioning the supported ends of surfboards and the like.

The tray frame may optionally include a receiver 44 with a lateral hole 86, to enable the addition of a hitch 46 for towing a trailer even with the tray occupying the vehicles hitch receiver. The hitch 46 includes a lateral hole 88 and a ball 90. The hitch is inserted into the tray receiver until the lateral holes are aligned, and a second retaining pin 92 and cotter pin 94 secure the hitch to the tray. Alternatively, the ball may be coupled directly to the tray without a removable hitch.

This daisy-chaining feature may be built into a variety of other rack systems which occupy the vehicle's receiver, and is not necessarily limited to use with trays. For example, it could be used in conjunction with a hitch-mounted bicycle rack, enabling a car owner to simultaneously carry her mountain bikes and tow her camping trailer.

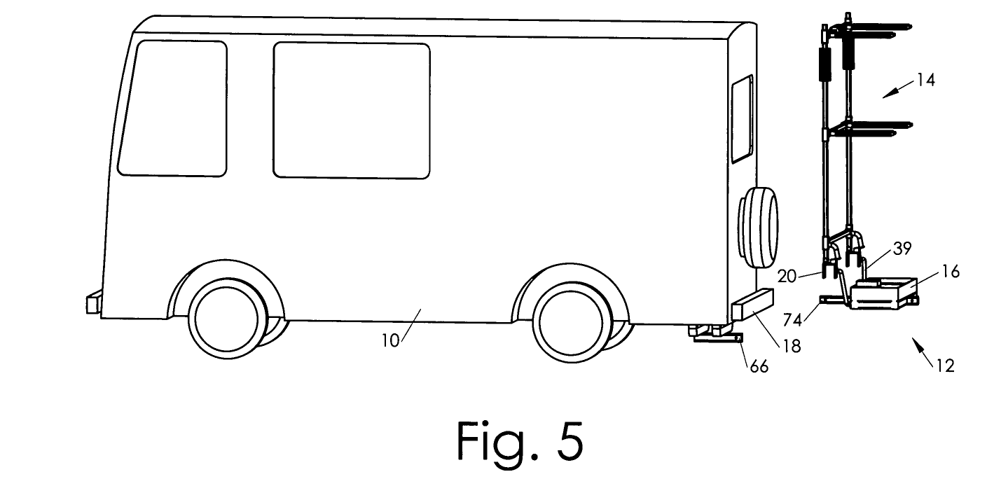

FIG. 5 illustrates the rack system 12 prior to its installation onto the RV 10. The rack system includes a rack 14 having bumper couplers 20 which are installed onto the RV's bumper 18. The rack system also includes a tray 16 having a hitch 74 which is installed into the RV's hitch receiver 66. The tray also has stabilizer bars 39 which are coupled to the bumper couplers, typically after the rack is installed on the bumper and the tray is installed in the hitch receiver.

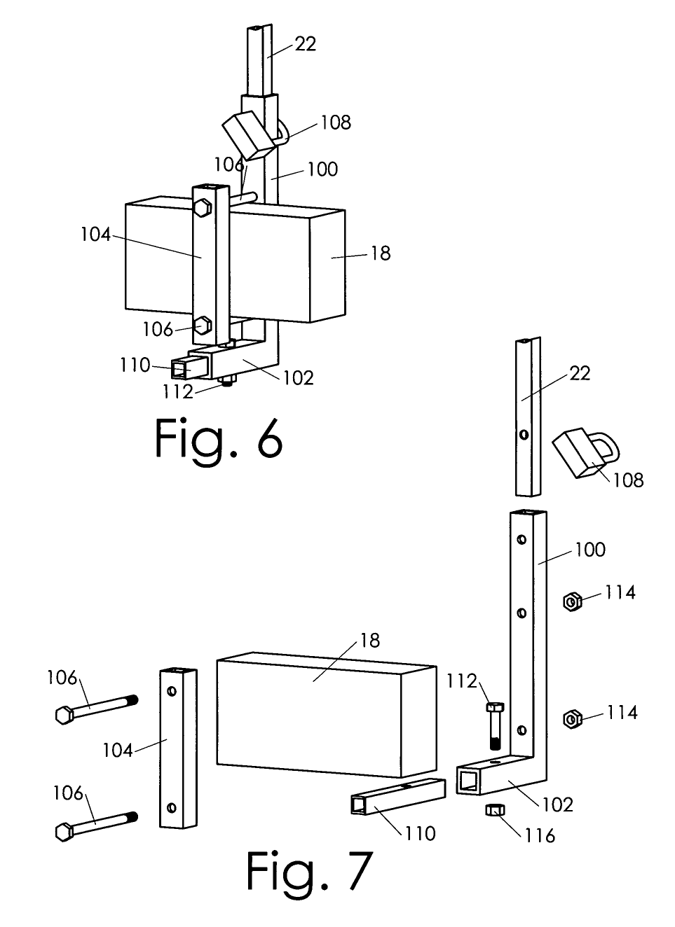

FIG. 6 illustrates an alternate bumper mounting system, which couples to the bumper 18 in a somewhat different manner than the system described above. The bumper is illustrated as viewed from the right rear of the RV (not shown). The bumper coupler includes a main bracket 100 which fits behind the bumper and a bottom bracket 102 which fits beneath the bumper. In some embodiments, the main bracket and the bottom bracket are a monolithic structure, as shown. An outer bracket 104 and the main bracket sandwich the bumper and are held firmly in place by bolts 106.

A vertical rail 22 of the rack slips into or over the main bracket, and is held in place by a bolt (not shown) or by a padlock 108. A stabilizer bar 110 slips into or over the bottom bracket, and is held in place by a bolt 112 or a padlock (not shown).

FIG. 7 illustrates this alternate bumper mounting system in an exploded view. The bolts 106 which hold the outer bracket 104 and the main bracket 100 to the bumper are secured by nuts 114 or by other suitable means such as locks, welds, or the like. The bolt 112 which holds the stabilizer bar 110 to the bottom bracket 102 is secured by a nut 116 or by other suitable means.

While the invention has been described with reference to coupling the rack to the back end of the RV, the invention may be practiced in other situations, as well, such as in the form of a rack adapted for coupling to the front bumper, or a rack for coupling to a bumper or rail attached to a vertical side of the RV. And while the invention has been described with reference to its use with an RV, it may of course be adapted for use with a variety of other vehicles, such as trailers, campers, SUVs, passenger cars, boats, and so forth. Most typically, such vehicles will have a frame, with a body coupled to the frame. The hitch receiver is usually coupled to the frame.

The various features illustrated in the figures may be combined in many ways, and should not be interpreted as though limited to the specific embodiments in which they were explained and shown. Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

1. A rack system for carrying cargo items on a vehicle having a substantially vertical surface, a bumper, and a hitch receiver, the rack system comprising:
bumper connectors for coupling to the bumper;
vertical rails;
horizontal rails connected to the vertical rails;
at least one of the vertical rails and the horizontal rails coupled to the bumper connectors; and
support bars extending substantially longitudinally and coupled to at least one of the vertical and horizontal rails, for supporting the cargo items.

2. The rack system of claim 1 wherein the substantially vertical surface comprises a back end of the vehicle, and the bumper comprises a rear bumper at the back end.

3. The rack system of claim 1 further comprising:
a tray for supporting weight of the cargo items.

4. The rack system of claim 3 wherein:
the tray is adapted for coupling to the hitch receiver.

5. The rack system of claim 3 further comprising:
at least one stabilizer bar coupled to the tray and to a bumper connector.

6. The rack system of claim 3 further comprising:
a combination lockbox securely coupled to the tray.

7. The rack system of claim 1 further comprising:
rail connectors coupling the horizontal rails to the vertical rails.

8. The rack system of claim 7 wherein:
at least some of the rail connectors are movable to enable repositioning of at least one of the rails.

9. The rack system of claim 1 wherein:
the at least one of the vertical rails and the horizontal rails is pivotably coupled to the bumper connectors.

10. The rack system of claim 9 further comprising:
a spring coupled to at least one of the bumper connectors to maintain an upper portion of the rack system against the vehicle under pressure.

11. The rack system of claim 1 further comprising:
at least one pad coupled to the rails to protect the vehicle from damage by the rack system.

12. The rack system of claim 1 further comprising:
bar connectors coupling the support bars to the rails.

13. The rack system of claim 12 wherein:
at least one of the bar connectors is movable to enable repositioning of its support bar to adapt the rack system for carrying different cargo items.

14. A cargo rack for carrying elongated cargo such as surfboards on a substantially vertical surface of a vehicle such as an RV, the cargo rack comprising:
bumper connectors for coupling to a bumper of the vehicle;
vertical rails coupled to the bumper connectors;
horizontal rails coupled to the vertical rails;
support bars coupled to the horizontal rails and extending backward for holding the elongated cargo in position; and
a tray for coupling to a hitch receiver of the vehicle, for bearing the weight of the elongated cargo.

15. The cargo rack of claim 14 wherein the substantially vertical surface comprises a back end of the vehicle, and the bumper comprises a rear bumper of the vehicle.

16. The cargo rack of claim 14 wherein:
at least one of the horizontal rails is slidably coupled to the vertical rails.

17. The cargo rack of claim 16 wherein:
at least one of the support bars is slidably coupled to the horizontal rails.

18. The cargo rack of claim 14 further comprising:
at least one stabilizer coupled to the tray and to one of a bumper connector and a vertical rail.

19. The cargo rack of claim 14 further comprising:
springs coupled to the vertical rails and to the bumper connectors for pressing the cargo rack against the back of the vehicle.

20. The cargo rack of claim 14 wherein:
the cargo rack is adapted for being mounted to the vehicle without any modifications of the vehicle, with the cargo rack being connected to the vehicle only at the bumper and the receiver hitch.

21. The cargo rack of claim 14 wherein:
the cargo rack is adapted for carrying at least one surfboard.

22. The cargo rack of claim 14 wherein:
the cargo rack is adapted for carrying at least one of a canoe and a kayak.

23. The cargo rack of claim 14 wherein:
the cargo rack is adapted for carrying a ladder.

24. The cargo rack of claim 14 wherein:
the support bars can be repositioned to adapt the cargo rack for carrying a variety of cargo items.

25. A vehicle comprising:
a frame;
a body coupled to the frame;
a bumper coupled to the frame at a rear of the body;
a hitch receiver coupled to the frame at the rear of the body;
a cargo rack coupled only to the bumper and including,
vertical rails,
horizontal rails coupled to the vertical rails, and
support bars coupled to the horizontal rails for holding cargo items in position; and
a tray coupled to the hitch receiver for bearing the weight of the cargo items.

26. The vehicle of claim 25 wherein the vehicle comprises:
one of an RV, a trailer, a truck, a camper, an SUV, and a passenger car.

27. The vehicle of claim 25 wherein:
the support bars are movably coupled to the horizontal rails, whereby they may be repositioned to adapt the cargo rack for use with a variety of cargo items.

28. An apparatus for use with a motor vehicle and a trailer, the apparatus comprising:
first means for carrying cargo items;
second means, coupled to the first means, for coupling to a hitch receiver of the motor vehicle;
third means, coupled to one of the first means and the second means, for coupling to a hitch of the trailer;
whereby the motor vehicle is enabled to simultaneously carry the cargo items and tow the trailer.

29. The apparatus of claim 28 wherein:
the first means comprises a tray.

30. The apparatus of claim 28 wherein:
the first means comprises a rack.

31. The apparatus of claim 28 wherein:
the third means comprises a hitch receiver for coupling to a removable hitch module.

32. The apparatus of claim 31 further comprising:
the hitch module.

33. The apparatus of claim 28 wherein:
the third means comprises an integral hitch to which a ball may be coupled for towing the trailer.
